(19) United States
(12) Patent Application Publication
(10) Pub. No.: US 2007/0056883 A1
(43) Pub. Date: Mar. 15, 2007

(54) Topsoil screening device

(76) Inventor: Raymind A. Torrey JR., (US)

Correspondence Address: HOWARD J. WALTER JR., 66 BACON DR, SHELBURNE, VT, 05482-7495, US

(21) Appl. No.: 11/518,728

(22) Filed: Sep. 9, 2006

Related U.S. Application Data
(60) Provisional application No. 60/716,009, filed on Sep. 10, 2005.

(51) Int. Cl. B07B 1/49

(52) U.S. Cl. 209/394

(57) ABSTRACT

A top soil screening device comprising a plurality of screening racks, each rack comprising a plurality of interdigitated moveable and stationary bars is described. Drive means moves the moveable rack up and down such that there is a fixed phase relationship between the moveable racks which evenly distributes the weight of any load of soil to be screened across all of the screening racks.

### REFERENCE TO PRIORITY DOCUMENT

Applicant hereby claims priority of U.S. Provisional Application Ser. No. 60/716,009 filed Sep. 10, 2005.

### BACKGROUND OF THE INVENTION

This invention relates to solid separation devices and particularly to screening devices useful to separate soil into useful topsoil and oversize materials such as rocks, wooden materials and other oversize items.

Such devices have been used for over one hundred years and are known by such names as screeners, grizzlies and sorters. As is common in other areas of technologies, a large number of different solutions to a particular technical problem is an indication of the seriousness of the problem. When known efficient solutions to a problem are known, few variations will be found. However, when known solutions are inadequate, many variations and solutions have been proposed.

In the technology of soil separators, there is a multitude of solutions; as there is no easy or best known implementation known.

Known soil separators include those in which relatively large quantities of unscreened earth onto a large receiver including one or more sets of screens or parallel bars which allow soil to pass through spaces in the screen or bars while the remainder of material too large to pass through is discarded. In many proposals the screen or bars are moved or vibrated to assist in separation.

In an effort to obtain more efficiency, improvements have included more and more complicated devices and features.

A typical separator or grizzly consists of a screen, usually comprising a screen of perforated material or parallel bars mounted at an angle to the ground on a frame such that material to be separated is dumped by a bucket loader or other delivering means, such as a conveyor belt. The screen may be vibrated causing some of the deposited material to pass through the screen while the remainder of material too large to pass through the screen falls off of the inclined screen to the ground or other receiving device.

Elaborate systems have been developed to increase the efficiency of the screening devices but at the risk of increasing the complexity and sensitivity of the screening devices to breakdown and failure.

### SUMMARY OF THE INVENTION

It is an object of the instant invention to provide an improved soil screener which has few components and reduced likelihood of failure.

Another object of the invention is to provide a screener that is self-cleaning and not subject to clogging.

The subject invention provides efficient soil separation with a minimum number of moveable parts and is capable of operating in the presence of oversize items without jamming. The separator if the invention is capable of handling large loads of mixed materials. The present invention provides these benefits by using a plurality of vertically oscillating screening decks have a predetermined relationship to each other so as to distribute the load to the driving mechanism such that very low torque is required to operate the screener. By providing adequate vertical movement between moveable and fixed racks of interdigitated horizontally extending bars, it becomes impossible to create jams as the moveable bars separate from the stationary bars to all but eliminate jamming. Moving multiple moveable racks in a phased relation to each other allows even distribution of the weight of the input load, reducing the strain and torque on the drive motor.

These and other objects are achieved by the instant invention as further described in the accompanying description and drawings.

### DESCRIPTION OF THE DRAWINGS

FIG. 1 is an elevation view of the front of the soil screener of the invention.

FIG. 2 is an elevation view of the back of the screener of the invention showing the plurality of moveable racks at different vertical positions.

FIG. 3 is an oblique view of the top of one of the sections of racks, showing their attachment to the front of the screener.

FIG. 4 is a partial sectional view of one of the journal means used to provide vertical movement of the moveable racks.

### DESCRIPTION OF THE PREFERRED EMBODIMENT

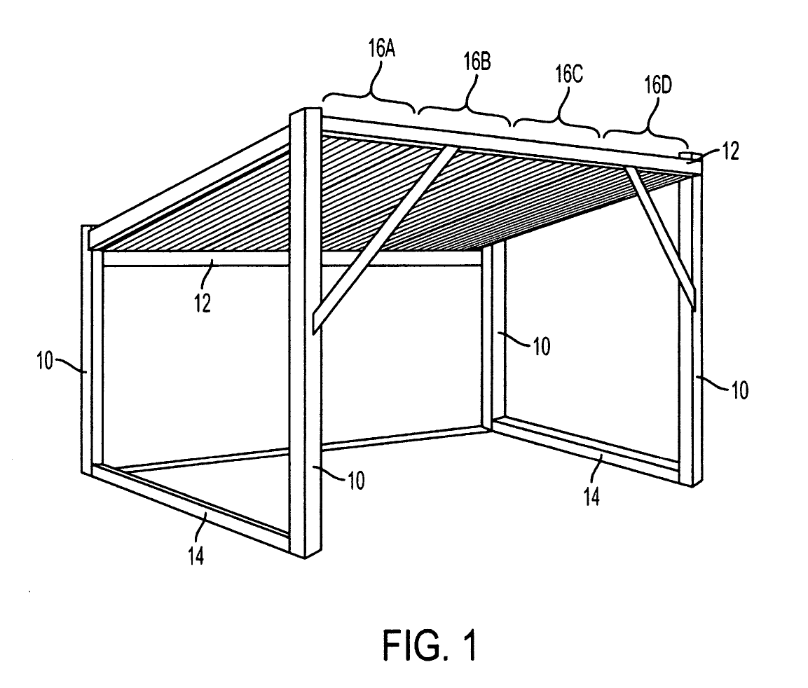

Referring to FIG. 1 there is shown the front of the screener and the large receiving region for screened top soil or other material. The screener includes a frame comprising four corner posts 10, horizontal cross bars 12 and lower bars 14. On top of the frame are four separately operable screening units 16A, 16B. 16C and 16D. Each screening unit comprises a plurality of interdigitated vertically moveable and stationary steel bars. Solid sides and rear panels may be provided to maintain separation between screened material and unscreened material.

The bars of the moveable racks are interdigitated with the stationary rack as has been practiced in the past. However, the moveable racks are cammed together in a fixed phase relationship, as described below.

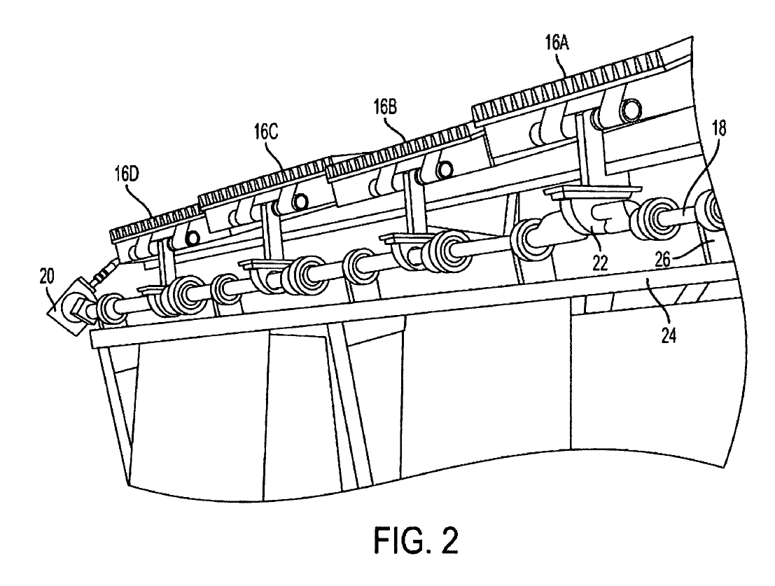

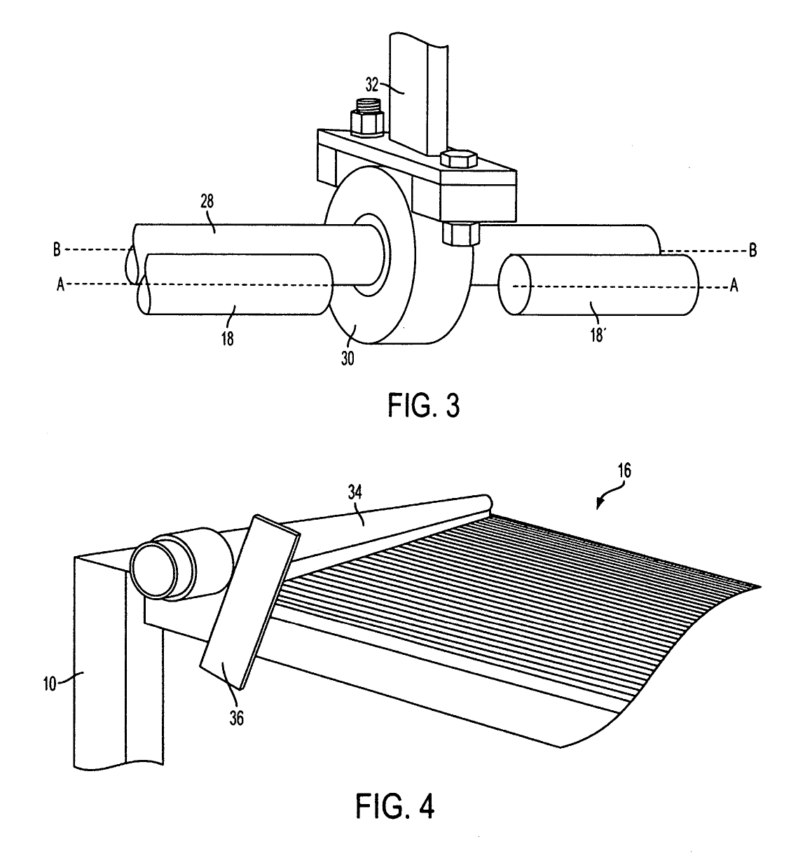

FIG. 2 shows the rear of the screener including the moveable ends of the racks 15, each of which is fixed to a horizontal shaft 18 turned by a hydraulic motor 20 mounted at the far end of the shaft 18. In order to move the free ends of the moveable racks each rack is attached to the shaft 18 by a journal means 22. The journal means 22 is illustrated in greater detail in FIG. 3. Although a crank shaft could be used to drive the moveable racks, this embodiment achieves the same result by cutting the shaft 18 and welding a short piece of shaft to the cut ends of the shaft. The welded section of shaft is positioned at a phase angle of 90 degrees with respect to it's adjacent neighbor. This positions the racks such that as the shaft 18 turns, counter clockwise as shown in FIG. 2, rack 16A will be in its highest position, rack 16B will be moving downward at a point halfway between its top and bottom position, rack 16C will be in its lowest position and rack 16D will be moving upward halfway between top and bottom.

It is this phased positioning of the moveable racks that allows the even distribution of the work load across the screener, assuming that the work load is relatively evenly distributed across the top of the screener. One half of the work load is always moving upward and one half is moving downward. To the extent that the work load is evenly distributed, the torque required by the drive motor 20 is minimal and, in fact, the shaft can be turned easily by hand.

The drive shaft 18 is mounted to the frame of the screener on a beam 24 by a plurality of fixed journal bearings 26.

Referring now to FIG. 3, there is shown the detail in the method of forming a crank shaft out of a single piece of round stack. The stock is cut, forming a first piece of shaft 18 and a second piece 18′. A stub section 28 of round stock is welded to the main part of the drive shaft 18. The stub section includes a bearing housing 30 to which is mounted a rack supporting member 32. As indicated above, each stub section is welded in a phased relation to the remaining sections.

While four phased rack sections 16 are shown, additional sections could be used in which the phasing would be adjusted such that the work load is evenly distributed to the drive shaft.

FIG. 4 shows the upper end of the screener bars 16 which are welded to a round tube 34 which allows the moveable racks to pivot about the tube 34. A short piece of stock 36 is welded to the frame to prevent horizontal movement of the top of the bars.

In operation, the work load can be placed on the top of the racks 16 by a front end or bucket loader. The shaft can be driven by a hydraulic motor operated via a power take-off on a tractor, not shown. Because the work load is balanced, the drive shaft can be stopped or turning when the work load is deposited. The shaft is preferred to operate at about 300 rpm for best operation. The screener of the preferred embodiment has a deck six by 12 feet and can screen about three cubic yards of top soil at a time. This will allow adequate time for the screener to clean itself before the bucket loader can return with another load. If a conveyor is used to feed work load and remove screened soil, the rate of rotation can be adjusted for continuous operation.

While the invention has been shown in terms of a single preferred embodiment, those skilled in the art will realize that various modifications can be made without altering the spirit of the invention.

What is claimed is:

1. A material separator comprising a frame and a screening deck including:
a stationary rack comprising a plurality of stationary parallel bars;
a plurality of moveable racks, each comprising a plurality of parallel bars, each moveable rack being pivotable about its upper end and the bars of the moveable rack being interdigitated with bars of the stationary rack; and
drive means coupled to the moveable racks such that the moveable racks are raised and lowered in a fixed phase relationship to each other.

2. The material separator of claim 1 wherein there are four moveable racks and the phase relationship is 90 degrees with respect to adjacent moveable racks.
